(19) United States
(12) Patent Application Publication
(10) Pub. No.: US 2024/0187949 A1
(43) Pub. Date: Jun. 6, 2024

(54) BASE STATION DEVICE, COMMUNICATION METHOD, AND COMMUNICATION SYSTEM

(71) Applicant: FUJITSU LIMITED, Kawasaki-shi (JP)

(72) Inventor: AKIRA HIRATA, Yokohama (JP)

(73) Assignee: FUJITSU LIMITED, Kawasaki-shi (JP)

(21) Appl. No.: 18/441,363

(22) Filed: Feb. 14, 2024

Related U.S. Application Data
(63) Continuation of application No. PCT/JP2021/035627, filed on Sep. 28, 2021.

(51) Int. Cl. H04W 36/08; H04W 36/32

(52) U.S. Cl. CPC H04W 36/08; H04W 36/322

(57) ABSTRACT

A base station device includes, a notifier configured to notify, when detecting a fact that a terminal device is under a reflection communication, the terminal device of a reflection communication handover condition for a case where the reflection communication is performed, and a controller configured to perform, when the terminal device under the reflection communication with a movement source base station device performs handover, control to restrain the terminal device from performing handover to the movement source base station device.

### CROSS-REFERENCE TO RELATED APPLICATION

This application is a continuation application of International Application Number PCT/JP2021/035627 filed on Sep. 28, 2021 and designated the U.S., the entire contents of which are incorporated herein by reference.

### FIELD

The present disclosure relates to a base station device, a communication method, and a communication system.

### BACKGROUND

In recent years, communication systems with radio have been used. In wireless communication systems, wireless communication is realized by, for example, transmission and reception of radio waves between base station devices and terminal devices.

There is a case that a base station device is not able to transmit radio waves to a terminal device positioned inside an own communication area in a case where a shield such as a building exists inside the own communication area. In this case, it is likely that the terminal device is not able to wirelessly connect to the base station device even inside the communication area of the base station device. Some technologies reflect, using a reflection plate to reflect radio waves, the radio waves to a dead zone inside a communication area where radio waves do not reach.

Technologies relating to reflection plates for radio waves are described in the following Patent Literature.
Patent Literature 1: WO 2017/077898
Patent Literature 2: WO 2013/031114

### SUMMARY

A base station device that performs normal communication to directly wirelessly connect to a terminal device or reflection communication to communicate with a terminal device using radio waves reflected by a reflection device, the base station device includes,
a notifier configured to notify, when detecting a fact that the terminal device is under the reflection communication, the terminal device of a reflection communication handover condition for a case where the reflection communication is performed, and
a controller configured to perform, when the terminal device under the reflection communication with a movement source base station device performs handover, control to restrain the terminal device from performing handover to the movement source base station device.

The object and advantages will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating a configuration example of a wireless communication system 10.

FIG. 2 is a diagram illustrating a configuration example of a base station device 200.

FIG. 3 is a diagram illustrating a configuration example of a terminal device 100.

FIG. 4 is a diagram illustrating a configuration example of the reflection device 300.

FIG. 5 is a diagram illustrating a handover example of the terminal device 100 that is under reflection communication.

FIG. 6 is a diagram illustrating a sequence example of handover processing by the terminal device 100 that is under reflection communication.

FIG. 7 is a diagram illustrating a sequence example of handover processing by the terminal device 100 that is under reflection communication.

FIG. 8 is a diagram illustrating a processing flowchart example of the reflection communication HO processing of S1000.

FIG. 9 is a diagram illustrating a processing flowchart example of the reflection communication HO request reception processing of S2000.

FIG. 10 is a diagram illustrating a processing flowchart example of the ping-pong avoidance processing of S3000.

FIG. 11 is a diagram illustrating a sequence example of wireless connection.

FIG. 12 is a diagram illustrating a sequence example of notifying the base station device of the fact that the terminal device is under reflection communication after establishment of wireless connection.

FIG. 13 is a diagram illustrating an example of a condition (event) on which the terminal device 100 makes a report in an RRC connection reconfiguration procedure.

FIG. 14 is a diagram illustrating an example of information elements (IE) and a group name in handover processing.

FIG. 15 is a diagram illustrating an example of the presence or absence of handover for each reception level.

### DESCRIPTION OF EMBODIMENTS

Reflected waves by a reflection plate aim only to cover terminal devices in a dead zone. For this reason, reflected waves are, for example, not stably supplied over a wide range, and the number of adaptable terminal devices may be limited. Accordingly, terminal devices preferably reduce a communication time using reflected waves to the shortest time as possible.

A communication system that uses reflected waves by a reflection plate enables a reduction in a communication time using reflected waves of a terminal device.

### First Embodiment

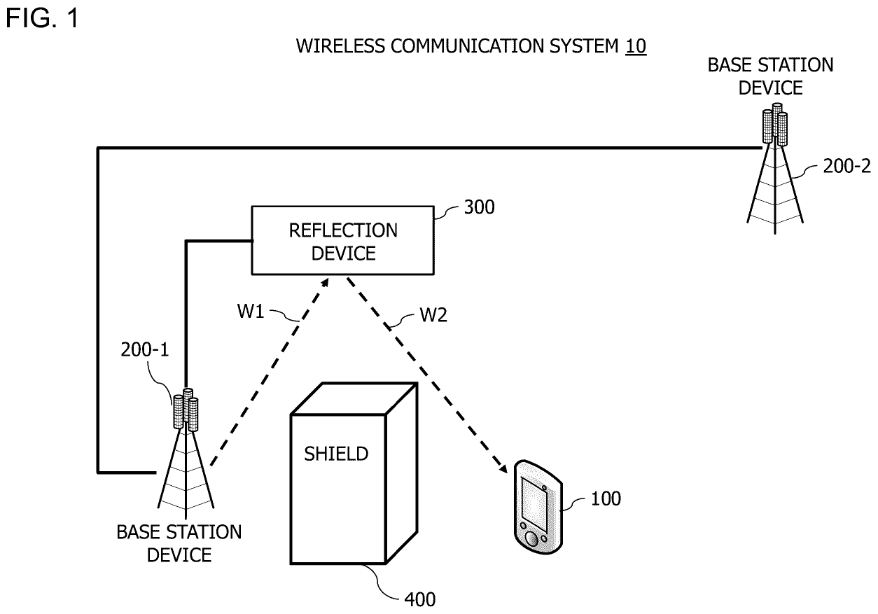

A first embodiment will be described. FIG. 1 is a diagram illustrating a configuration example of a wireless communication system 10. The wireless communication system 10 has a reflection device 300, a terminal device 100, and base station devices 200-1 and 200-2. Further, a shield 400 exists inside a communication area of the base station device 200-1 in the wireless communication system 10.

Each of the base station devices 200-1 and 200-2 (hereinafter called base station devices 200 according to circumstances) has a communication area. The base station devices 200 wirelessly connect to terminal devices 100-1 and 100-2 inside the communication areas to perform communication. Further, the base station devices 200 have a directional antenna, and are capable of controlling a radio wave transmission direction with a change in a multi-value modulation system or the directional antenna.

The terminal devices 100 are communication devices that wirelessly connect to the base station devices 200 to perform wireless communication with other terminal devices, and are, for example, smart phones or tablet terminals.

The reflection device 300 is a device that reflects radio waves transmitted by the base station devices 200 or the terminal devices 100 and transmits reflected waves. The reflection device 300 reflects received radio waves according to, for example, control by the base station devices 200. The reflected waves include, for example, notification information transmitted by the base station devices 200. Further, the reflected waves include signals for communication or control transmitted and received in the wireless communication between the base station devices 200 and the terminal devices 100.

The reflection device 300 is, for example, a reconfigurable intelligent surface (RIS). The RIS is a reflection plate using a metasurface. The metasurface is a material in which structures smaller in size than the wavelengths of radio waves are assumed as atoms or molecules and arrayed in the reflection device to realize electromagnetic properties (such as permittivity and magnetic permeability) not existing in the natural world. Using the metasurface, the RIS is capable of reflecting each of a plurality of radio waves in a desired direction. Further, the RIS may be capable of operating, for example, information included in reflected waves and adding and updating prescribed information.

The shield 400 is an object that shields radio waves. Under the existence of the shield 400, the base station devices 200 are not enabled to perform transmission and reception of radio waves with terminal devices 100 positioned at some specific areas (disconnected areas) directly (without the reflection device 300). In order to complement wireless communication of the terminal devices 100 positioned at disconnected areas, the base station devices 200 use the reflection device 300 and transmit reflected waves to the disconnected areas.

In FIG. 1, the terminal device 100 is positioned at a disconnected area in which the terminal device 100 is not enabled to directly wirelessly connect to the base station device 200-1. Using reflected waves W2 generated when the reflection device 300 reflects radio waves W1 transmitted by the base station device 200-1, the terminal device 100 wirelessly connects to the base station device 200-1.

In the wireless communication system 10, an HO condition on which handover is liable to be performed (facilitated) than a handover (HO) condition in normal communication (communication using normal radio waves other than reflected waves) is set in the terminal devices 100 that are under communication using reflected waves (hereinafter called reflection communication according to circumstances). Further, a (reinforced) HO condition on which handover to the base station devices 200 that are transmission sources of original reflected waves is less liable to be performed than a handover condition in normal communication is set in the terminal devices 100 that have performed reflection communication but have performed handover in the wireless communication system 10. In the wireless communication system 10, the terminal devices 100 are liable to perform handover under reflection communication, and are less liable to perform handover to the base station devices 200 that are transmission sources of reflected waves when having performed handover from reflection communication. Thus, the terminal devices 100 enable a reduction in a time under reflection communication.

Note that the two base station devices 200 are assumed in FIG. 1, but three or more base station devices 200 may be provided. Further, the two terminal devices 100 are assumed in FIG. 1, but one or three or more terminal devices 100 may be provided. In addition, the reflection device 300 may be controlled by one of or both the base station devices 200-1 and 200-2.

### Configuration Example of Base Station Device 200

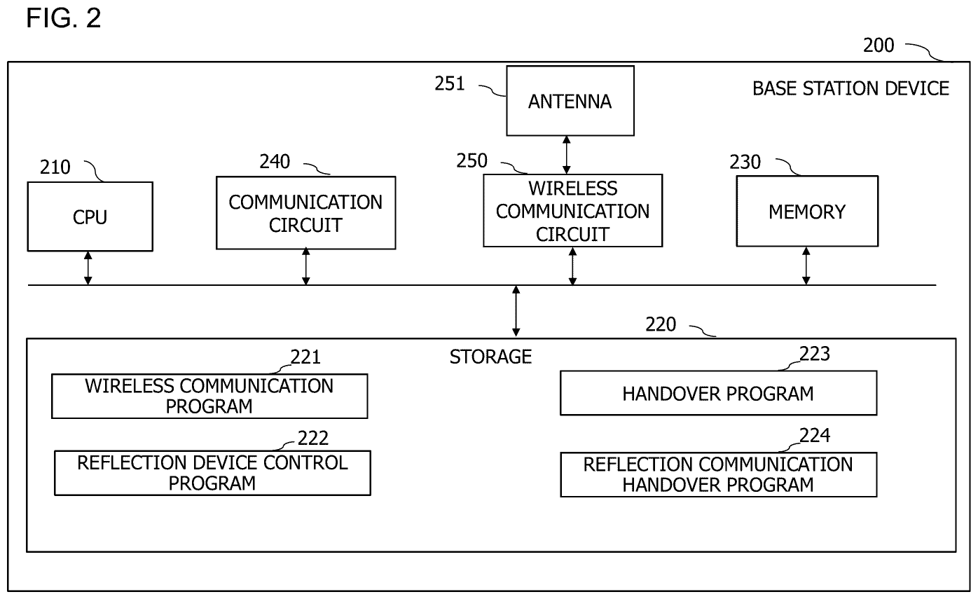

FIG. 2 is a diagram illustrating a configuration example of a base station device 200. The base station device 200 has a central processing unit (CPU) 210, a storage 220, a memory 230, a communication circuit 240, a wireless communication circuit 250, and an antenna 251.

The storage 220 is an auxiliary storage device such as a flash memory, a hard disk drive (HDD), and a solid-state drive (SSD) that stores a program or data. The storage 220 stores a wireless communication program 221, a reflection device control program 222, a handover program 223, and a reflection communication handover program 224.

The memory 230 is an area into which a program stored in the storage 220 is to be loaded. Further, the memory 230 may also be used as an area in which a program stores data.

The communication circuit 240 is a device that performs communication with another base station device 200 or the reflection device 300. The communication circuit 240 may be, for example, a wired communication circuit such as a network interface (NI) or a communication circuit that corresponds to wireless connection.

The wireless communication circuit 250 is a device that performs wireless communication with a terminal device 100 or performs wireless communication with the terminal device 100 via the reflection device 300. The wireless communication circuit 250 wirelessly connects to the terminal device 100 via the reflection device 300 or directly to realize wireless communication. The wireless communication circuit 250 has the antenna 251. The antenna 251 includes, for example, a directional antenna capable of controlling a radio wave transmission/reception direction.

The CPU 210 is a processor that loads a program stored in the storage 220 into the memory 230, runs the loaded program, constructs respective units, and realizes respective processing.

The CPU 210 performs wireless communication processing by running the wireless communication program 221. The wireless communication processing is processing to wirelessly connect to a terminal device 100 and realize communication to be performed by the terminal device 100.

The CPU 210 constructs a reflection control unit and performs reflection device control processing by running the reflection device control program 222. The reflection device control processing is processing to cause the reflection device 300 to perform reflection control. The base station device 200 provides instructions such as a reflection angle of reflected waves, a transmission output, information added to reflected waves (for example, information indicating reflected waves) to the reflection device 300.

The CPU 210 constructs a normal control unit and performs handover processing by running the handover program 223. The handover processing is processing to perform handover of a terminal device 100 that is under normal communication.

The CPU 210 constructs a control unit and a notification unit and performs reflection communication handover processing by running the reflection communication handover program 224. The reflection communication handover processing is processing to perform handover of a terminal device 100 that is under reflection communication. The reflection communication handover processing includes processing to set a reflection communication handover condition (such as a threshold of a reception level and an offset value) in a terminal device 100 that is under reflection communication. Further, the reflection communication handover processing includes processing to receive a request for handover (a notification indicating that a base station device satisfying a reflection communication handover condition has been detected) from a terminal device 100 that is under reflection communication and transmit permission of handover to the terminal device 100 when the handover is permitted by the base station device 200 that is a handover destination. Further, the reflection communication handover processing includes detection as to whether a terminal device 100 is under reflection communication and a notification of the fact that the terminal devices 100 is under reflection communication at the time of the detection to the terminal device 100. Further, the reflection processing handover processing includes processing to transmit instructions indicating the fact that a terminal device 100 having performed handover has performed reflection communication or avoids (restrains) handover to a source base station device 200 to a base station device 200 that is a handover destination.

### Configuration Example of Terminal Device 100

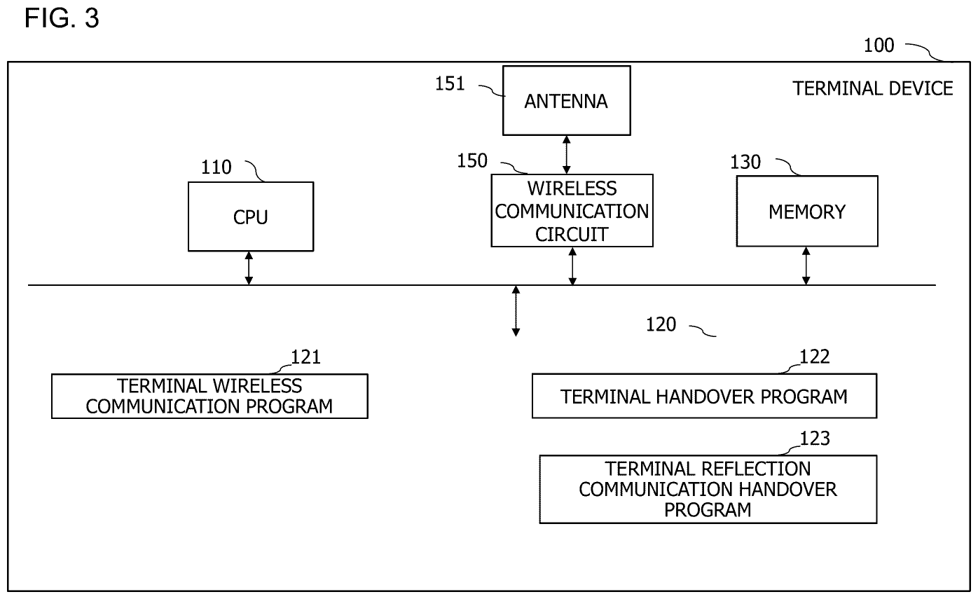

FIG. 3 is a diagram illustrating a configuration example of a terminal device 100. The terminal device 100 has a CPU 110, a storage 120, a memory 130, a wireless communication circuit 150, and an antenna 151.

The storage 120 is an auxiliary storage device such as a flash memory, an HDD, and an SSD that stores a program or data. The storage 120 stores a terminal wireless communication program 121, a terminal handover program 122, and a terminal reflection communication handover program 123.

The memory 130 is an area into which a program stored in the storage 120 is to be loaded. Further, the memory 130 may also be used as an area in which a program stores data.

The wireless communication circuit 150 is a device that performs wireless communication with a base station device 200. The wireless communication circuit 150 wirelessly connects to the base station device 200 via the reflection device 300 or directly to realize wireless communication. The wireless communication circuit 150 has the antenna 151. The antenna 151 includes, for example, a directional antenna capable of controlling a radio wave transmission/reception direction.

The CPU 110 is a processor that loads a program stored in the storage 120 into the memory 130, runs the loaded program, constructs respective units, and realizes respective processing.

The CPU 110 performs terminal wireless communication processing by running the terminal wireless communication program 121. The terminal wireless communication processing is processing to wirelessly connect to a base station device 200 and realize communication with another terminal device 100 or the base station device 200.

The CPU 110 performs terminal handover processing by running the terminal handover program 122. The terminal handover processing is processing to receive permission of handover from a base station device 200 and perform the handover to a movement destination base station device 200 when the terminal device 100 is under normal communication.

The CPU 110 performs terminal reflection communication handover processing by running the terminal reflection communication handover program 123. The terminal reflection communication handover processing is processing to receive permission of handover from a base station device 200 and perform the handover to a movement destination base station device 200 when the terminal device 100 is under reflection communication. The terminal reflection communication handover processing includes detection as to whether the terminal device 100 is under reflection communication and a notification of the fact that the terminal device 100 is under reflection communication at the time of the detection to a base station device 200. Further, the terminal reflection communication handover processing includes processing to make a request for reflection communication handover to a base station device 200 when the base station device 200 satisfying a reflection communication handover condition is detected.

### Configuration Example of Reflection Device 300

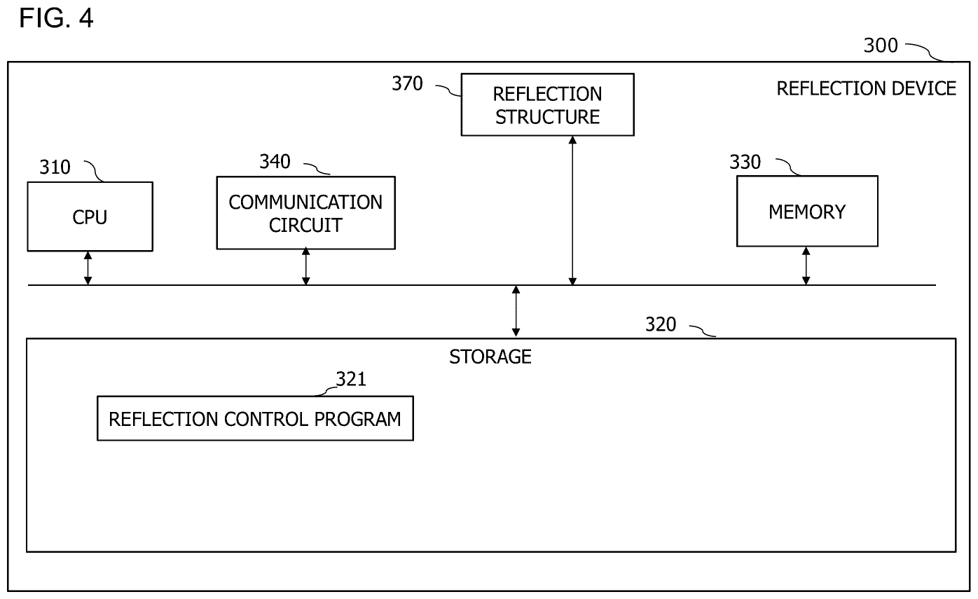

FIG. 4 is a diagram illustrating a configuration example of the reflection device 300. The reflection device 300 has a CPU 310, a storage 320, a memory 330, a communication circuit 340, and a reflection structure 370.

The storage 320 is an auxiliary storage device such as a flash memory, an HDD, and an SSD that stores a program or data. The storage 320 stores a reflection control program 321.

The memory 330 is an area into which a program stored in the storage 320 is to be loaded. Further, the memory 330 may also be used as an area in which a program stores data.

The communication circuit 340 is a device that performs communication with a base station device 200. The communication circuit 340 may be, for example, a wired communication circuit such as an NI or a communication circuit that corresponds to wireless connection.

The reflection structure 370 is an aggregate of a plurality of structures that receive radio waves transmitted by a base station device 200 or a terminal device 100 and transmit the radio waves at a desired angle. The reflection structure 370 is capable of receiving and transmitting (reflecting) radio waves in units of the structures.

The CPU 310 is a processor that loads a program stored in the storage 320 into the memory 330, runs the loaded program, constructs respective units, and realizes respective processing.

The CPU 310 performs reflection control processing by running the reflection control program 321. The reflection control processing is processing to control reflection of received radio waves. The reflection device 300 performs reflection control according to instructions from a base station device 200 in the reflection control processing. Further, the reflection device 300 performs reflection control so that reflected waves reach a specific area (for example, an area where radio waves from the base station device 200 do not reach). Further, the reflection device 300 is capable of adjusting an angle of reflected waves, a frequency, a beam width, or the like. In addition, the reflection device 300 may also be capable of adding prescribed information to reflected waves or changing (updating) some information.

Handover Processing under Reflection Communication Handover processing of the terminal device 100 that is under reflection communication will be described.

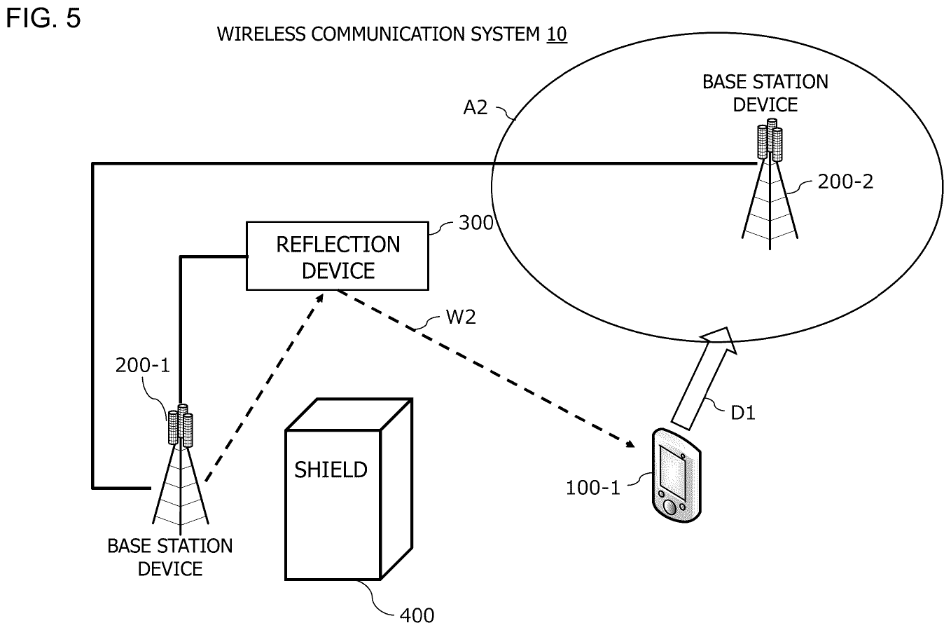

FIG. 5 is a diagram illustrating a handover example of the terminal device 100 that is under reflection communication. The terminal device 100 is under wireless communication with the base station device 200-1 via the reflected waves W2.

The terminal device 100 moves to a direction D1 of the base station device 200-2. The terminal device 100 moves to a position at which radio waves transmitted from the base station device 200-2 are receivable (detectable).

Here, the terminal device 100 measures a reception level of the radio waves transmitted from the base station device 200-2. The terminal device 100 performs handover to the base station device 200-2 when an HO condition in reflection communication is satisfied even if an HO condition in normal communication is not satisfied.

In addition, the base station device 200-2 recognizes the fact that the terminal device 100 has performed reflection communication with the base station device 200-1, and controls the terminal device 100 so that the terminal device 100 is less liable to perform handover (the terminal device 100 is restrained from performing handover) to the base station device 200-1.

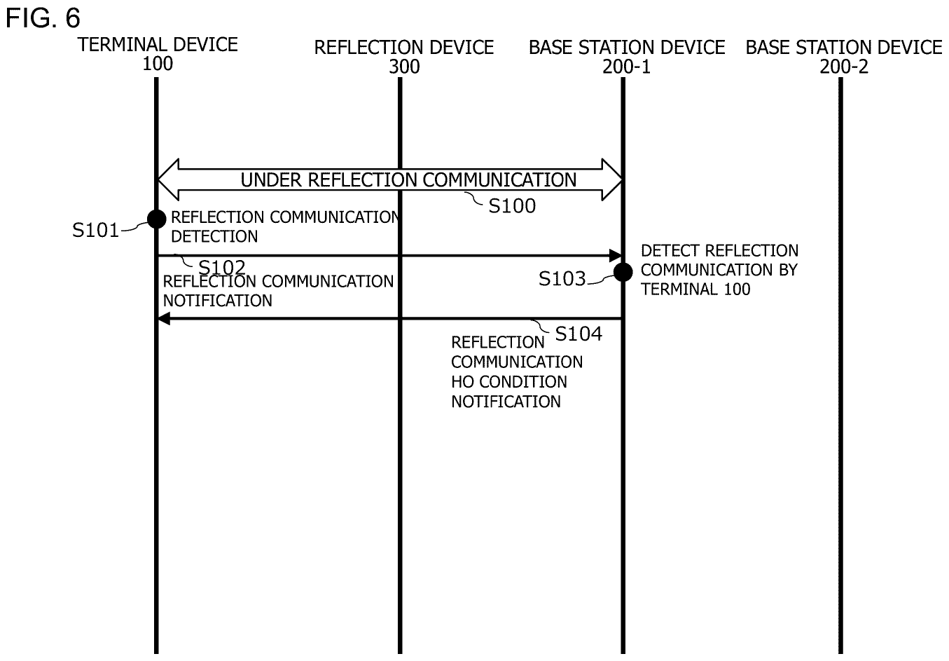

FIG. 6 is a diagram illustrating a sequence example of handover processing by the terminal device 100 that is under reflection communication. The terminal device 100 is under reflection communication with the base station device 200-1 via the reflection device 300 (S100).

The terminal device 100 detects the fact that the own device is under reflection communication (S101). The detection of reflection communication will be described in detail later.

When detecting the fact that the own device is under reflection communication (S101), the terminal device 100 transmits a reflection communication notification indicating that the own device is under reflection communication to the base station device 200-1 (S102). A notification method for notifying the base station device 200-1 of the fact that the terminal device 100 is under reflection communication will be described in detail later.

When receiving the reflection communication notification from the terminal device 100 (S102) and detecting the fact that the terminal device 100 is under reflection communication (S103), the base station device 200-1 transmits a reflection communication HO condition notification to the terminal device 100 (S104).

The reflection communication HO condition notification includes an HO condition in reflection communication (reflection communication HO condition). The reflection communication HO condition is a condition on which handover is more liable to be performed (facilitated) than an HO condition in normal communication (normal communication HO condition). The reflection communication HO condition is, for example, a reception level (reflection HO reception level) lower than a reception level (normal HO reception level) of radio waves (a signal) transmitted from an adjacent base station device that is an HO destination in the normal communication HO condition. With a lowered reception level of radio waves transmitted from a base station device that is an HO destination, the terminal device 100 that is under reflection communication is liable to perform handover to the adjacent base station device. A notification method for notifying the terminal device 100 of the reflection communication HO condition will be described in detail later.

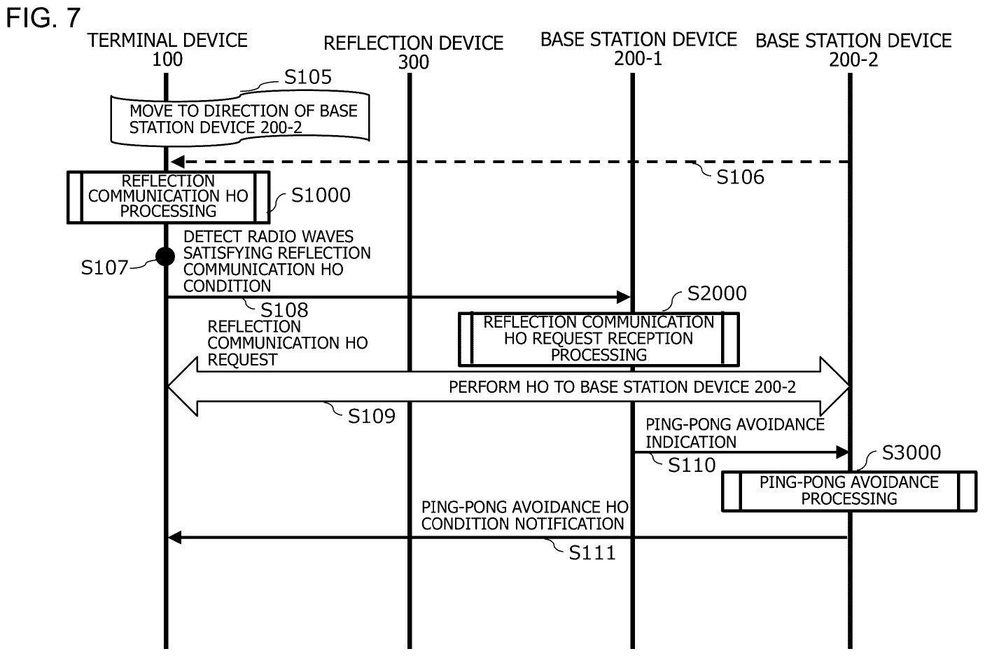

FIG. 7 is a diagram illustrating a sequence example of handover processing by the terminal device 100 that is under reflection communication. The terminal device 100 and the base station device 200-1 recognize the fact that the terminal device 100 is under reflection communication.

The terminal device 100 moves to a direction of the base station device 200-2 (S105). Then, the terminal device 100 receives radio waves transmitted by the base station device 200-2 (S106).

Upon receiving the radio waves from the base station device 200-2 (adjacent base station device) (S106), the terminal device 100 performs reflection communication HO processing (S1000).

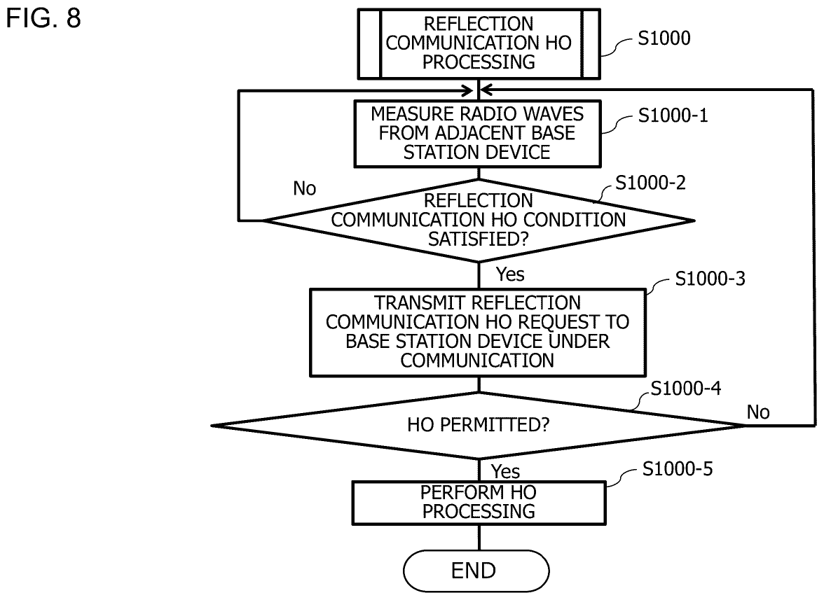

FIG. 8 is a diagram illustrating a processing flowchart example of the reflection communication HO processing of S1000. The terminal device 100 measures radio waves from an adjacent base station device (S1000-1). In the processing of S1000-1, the terminal device 100 measures, for example, reception strength, noise (interference degree), or the like of the radio waves.

When a measurement result of the radio waves does not satisfy a reflection communication HO condition (No in S1000-2), the terminal device 100 performs the processing of S1000-1 again.

On the other hand, when the measurement result of the radio waves satisfies the reflection communication HO condition (Yes in S1000-2), the terminal device 100 transmits a reflection communication HO request to request for reflection communication HO to a base station device 200 with which the terminal device 100 is under communication (S1000-3).

The terminal device 100 waits for a response to the reflection communication HO request from the base station device 200 with which the terminal device 100 is under communication, and receives the response. When handover is not permitted (No in S1000-4), the terminal device 100 performs the processing of S1000-1 again.

On the other hand, when the handover is permitted (Yes in S1000-4), the terminal device 100 performs HO processing (S1000-5) and ends the processing.

Referring back to the sequence of FIG. 7, the terminal device 100 determines that a measurement result of the radio waves from the base station device 200-2 that is an adjacent base station device satisfies a reflection communication HO condition in the reflection communication HO processing of S1000 (S107 and Yes in S1000-2 of FIG. 8), and transmits a reflection communication HO request to the base station device 200-1 (S108 and S1000-3 of FIG. 8).

Upon receiving the reflection communication HO request (S108), the base station device 200-1 performs reflection communication HO request reception processing (S2000).

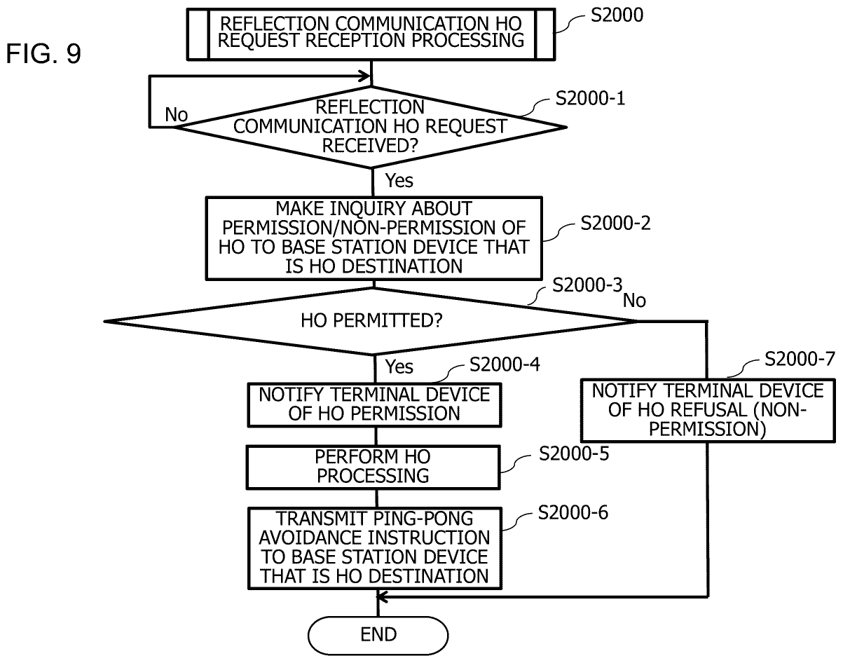

FIG. 9 is a diagram illustrating a processing flowchart example of the reflection communication HO request reception processing of S2000. A base station device 200 waits for reception of a reflection communication HO request (No in S2000-1). Upon receiving the reflection communication HO request (Yes in S2000-1), the base station device 200 makes an inquiry about whether handover of the terminal device 100 is permitted to a base station device 200 that is a handover destination (S2000-2).

When the handover is not permitted (No in S2000-3), the base station device 200 transmits (provides a notification of) HO refusal (non-permission) to the terminal device 100 (S2000-7) and ends the processing.

On the other hand, when the handover is permitted (Yes in S2000-3), the base station device 200 transmits (provides a notification of) HO permission to the terminal device 100 (S2000-4). Then, the base station device 200 performs handover processing (S2000-5), transmits a ping-pong avoidance indication to the base station device 200 that is a handover destination (S2000-6), and ends the processing.

Processing of the base station device 200 that is a handover source includes, for example, processing to transmit information on the terminal device 100 (for example, information on a session, information on an edge, or the like) to the base station device 200 that is a handover destination. Further, the processing of the base station device 200 that is a handover source includes, for example, processing to disconnect wireless connection with the terminal device 100 and release a session after the terminal device 100 has succeeded in the handover, or the like.

The ping-pong avoidance indication is a message to indicate avoidance or restraint of ping-pong in which the terminal device 100 performs handover to the base station device 200 that is a handover source with which the terminal device 100 has performed reflection communication. The ping-pong avoidance indication will be described in detail later.

Referring back to the sequence of FIG. 7, the base station device 200-1 is permitted to perform handover by the base station device 200-2 (Yes in S2000-3 of FIG. 9), transmits HO permission to the terminal device 100 (S2000-4 of FIG. 9), and performs the HO to the base station device 200-2 (S109 and S2000-5 of FIG. 9) in the reflection communication HO request reception processing of S2000. Then, the base station device 200-1 transmits a ping-pong avoidance indication to the base station device 200-2 (S110 and S2000-6 of FIG. 9).

Upon receiving the ping-pong avoidance indication (S110), the base station device 200-2 performs ping-pong avoidance processing (S3000).

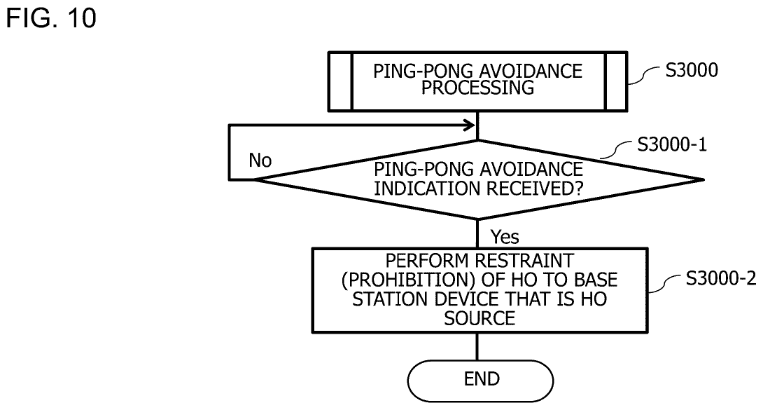

FIG. 10 is a diagram illustrating a processing flowchart example of the ping-pong avoidance processing of S3000. A base station device 200 waits for reception of a ping-pong avoidance indication (No in S3000-1). Upon receiving the ping-pong avoidance indication (Yes in S3000-1), the base station device 200 transmits a ping-pong avoidance HO condition notification including an HO condition for avoiding ping-pong to the terminal device 100 (3000-2) and ends the processing. The ping-pong avoidance HO condition notification will be described in detail later.

Referring back to the sequence of FIG. 7, the base station device 200-2 transmits a ping-pong avoidance HO condition notification to the terminal device 100 in the ping-pong avoidance processing of S3000 (S111 and S3000-2 of FIG. 10).

### Detection of Reflection Communication

The fact that the terminal device 100 is under reflection communication may only be detected by one of the terminal device 100 and the base station device 200-1.

In one detection method, the terminal device 100 determines whether the terminal device 100 is under reflection communication according to whether a determination bit included in a prescribed message is recognizable (receivable without causing an error). The base station device 200-1 transmits a message in which a determination bit is multiplexed with power lower than a prescribed value. The power lower than the prescribed value indicates, for example, the highest power among power with which the reflection device 300 is not enabled to perform reflection. That is, the determination bit transmitted with the power lower than the prescribed value is an information element that is recognizable by the terminal device 100 that performs communication on the side closer to the base station device 200-1 than the reflection device 300 but is not recognizable by the terminal device 100 that performs reflection communication. The terminal device 100 determines that the terminal device 100 is under reflection communication when the determination bit is not recognizable.

Further, in one detection method, the terminal device 100 determines whether the terminal device 100 is under reflection communication according to a position of the own device. The terminal device 100 stores information on a position at which reflected waves with prescribed power or higher reach (a position at which radio waves from the base station device 200-1 do not directly reach) in its memory in advance. Then, for example, the terminal device 100 acquires a position of the own device from a global positioning system (GPS), and compares the acquired position with the information stored in the memory to determine whether the own device is under reflection communication. Note that the base station device 200-1 may store information on a position at which reflected waves with prescribed power or higher reach, acquire information on a position of the terminal device 100 from the terminal device 100, and determine whether the terminal device 100 is under reflection communication.

Further, in one detection method, the terminal device 100 determines whether the terminal device 100 is under reflection communication according to whether information included only in reflected waves is acquirable. For example, the reflection device 300 receives radio waves from the base station device 200-1, and adds information indicating reflected waves to the received radio waves to generate reflection.

Notification Method for Notifying Base Station Device of Fact that Terminal Device is Under Reflection Communication

In the sequence of FIG. 6, the terminal device 100 notifies the base station device 200-1 of the fact that the own device is under reflection communication in the reflection communication notification. The reflection communication notification may be a newly-defined message or a part of a general message. An example of the notification method for notifying the base station device of the fact that the terminal device is under reflection communication will be described below.

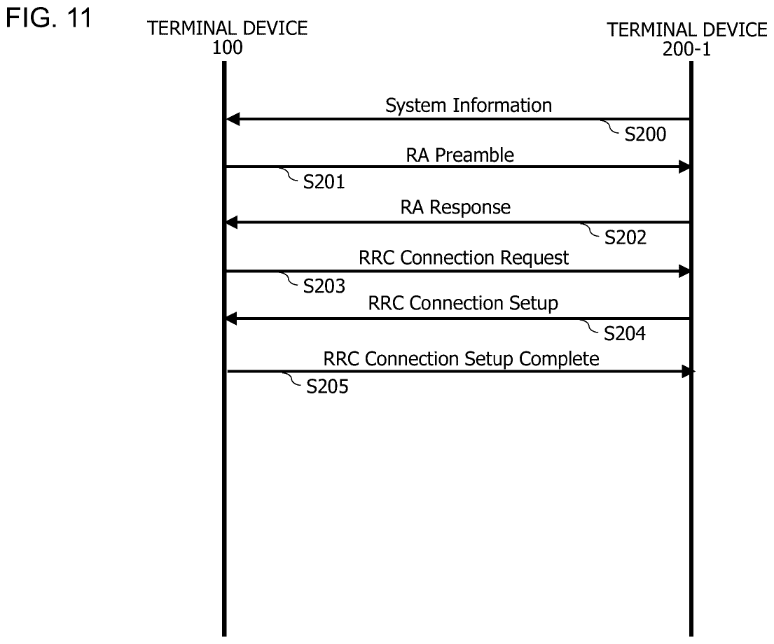

As a notification method for notifying the base station device of the fact that the terminal device is under reflection communication, there is, for example, a method performed in a series of procedures for starting wireless connection. FIG. 11 is a diagram illustrating a sequence example of wireless connection. In the description of FIG. 11, the names of messages in fifth-generation communication will be used as an example. However, the embodiment is not limited to the messages. The same applies to the following descriptions.

The base station device 200-1 notifies the terminal device 100 of system information by System Information (S200).

The terminal device 100 transmits a preamble signal to the base station device 200-1 by random access (RA) preamble (S201).

The base station device 200-1 transmits a response to the preamble signal to the terminal device 100 by RA Response (S202).

The terminal device 100 transmits RRC connection Request to request for connection in radio resource control (RRC) to the base station device 200-1 (S203).

The base station device 200-1 transmits RRC Connection Setup including setting information on the connection in the RRC to the terminal device 100 (S204).

The terminal device 100 establishes RRC connection, and transmits RRC Connection Setup Complete indicating the complete of the RRC connection to the base station device 200-1 (S205).

The base station device 200-1 may provide a notification of, for example, a setting value (for example, a threshold of a reception level or the like) indicating reflection communication by an information element (for example, EstablishmentCause) included in RA Response. The terminal device 100 detects reflection communication according to the setting value, and notifies the base station device 200-1 of the fact that the terminal device 100 is under reflection communication.

Further, the terminal device 100 may add an information element indicating the fact that the terminal device 100 is under reflection communication to a message (for example, RA Preamble, RRC Connection Request, or RRC Connection Setup Complete) transmitted to the base station device 200-1.

Further, a new information element (IE) indicating the fact that the terminal device 100 is under reflection communication may be added in the wireless communication system 10.

Further, as another notification method for notifying the base station device of the fact that the terminal device is under reflection communication, there is, for example, a method performed after establishment of wireless connection.

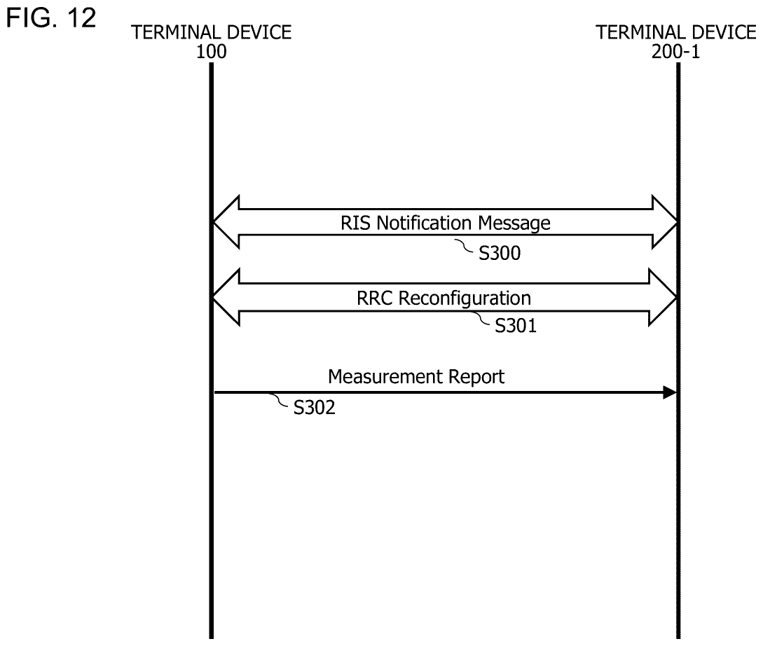

FIG. 12 is a diagram illustrating a sequence example of notifying the base station device of the fact that the terminal device is under reflection communication after establishment of wireless connection. In the wireless communication system 10, a new RRC message (RIS Notification Message) is defined, and the fact that the terminal device 100 is under reflection communication with the base station device 200-1 and information on the reflection communication are transmitted and received between the terminal device 100 and the base station device 200-1 (S300).

Further, RRC Reconfiguration is used, and the fact that the terminal device 100 is under reflection communication with the base station device 200-1 and information on the reflection communication are transmitted and received between the terminal device 100 and the base station device 200-1 (S301).

The base station device 200-1 notifies the terminal device 100 of, for example, a setting value indicating reflection communication by an RRC message. The terminal device 100 measures radio waves from the base station device 200-1, determines that the terminal device 100 is under reflection communication when a condition based on the setting value indicating the reflection communication is satisfied (for example, when the radio waves are lower than the setting value), and transmits Measurement Report with information indicating the fact that the terminal device 100 is under reflection communication to the base station device 200-1 (S302).

### Notification Method for Notifying Terminal Device of Reflection Communication HO Condition

In the sequence of FIG. 6, the base station device 200-1 notifies the terminal device 100 of an HO condition in the terminal device 100 that is under reflection communication in the reflection communication HO condition notification. The reflection communication HO condition notification may be a newly-defined message or a part of a general message. An example of the notification method for notifying the terminal device of a reflection communication HO condition will be described below.

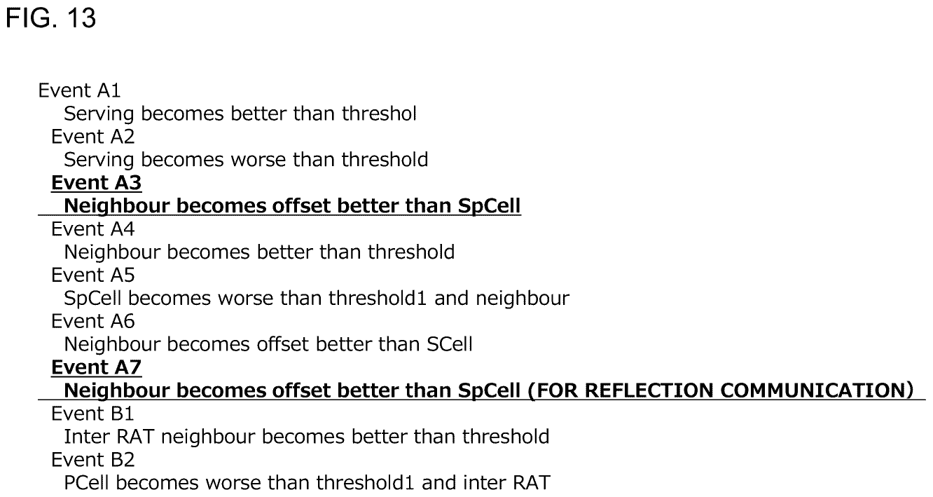

FIG. 13 is a diagram illustrating an example of a condition (event) on which the terminal device 100 makes a report in an RRC connection reconfiguration procedure. An event A3 is an event to instruct the terminal device 100 to make a report when a reception level of radio waves from an adjacent base station device 200 becomes higher (stronger) by an offset value than that from a base station device 200 with which the terminal device 100 is under communication. The event A3 is, for example, a general event. The base station device 200-1 makes an offset value in the event A3 of the terminal device 100 that is under reflection communication smaller than an offset value of the terminal device 100 that is under normal communication. Thus, the terminal device 100 that is under reflection communication performs handover even at a reception level from an adjacent base station device to which the terminal device 100 does not perform handover in normal communication.

Further, an event A7 may be newly set without changing an offset value in the general event A3. The event A7 is an event for a terminal device that is under reflection communication. The base station device 200-1 makes an offset value in the event A7 smaller than an offset value of the terminal device 100 that is under normal communication. Under reflection communication, the terminal device 100 performs, by using an offset value in the event A7 instead of the offset value in the event A3, handover even at a reception level from an adjacent base station device to which the terminal device 100 does not perform handover in normal communication.

Upon detecting an adjacent base station device at a reception level satisfying an offset value in the event A3 or A7, the terminal device 100 transmits, for example, MR to the base station device 200-1 to provide a notification of the fact that the adjacent base station device satisfying an HO condition under reflection communication has been detected.

### Ping-Pong Avoidance Indication

The ping-pong avoidance indication is a message provided by the base station device 200-1 that is a handover source to notify the base station device 200-2 that is a handover destination of the fact that the terminal device 100 has performed reflection communication. The ping-pong avoidance indication may be a newly-defined message or included in a general message. The ping-pong avoidance indication may be transmitted after the complete of handover as in the sequence of FIG. 7.

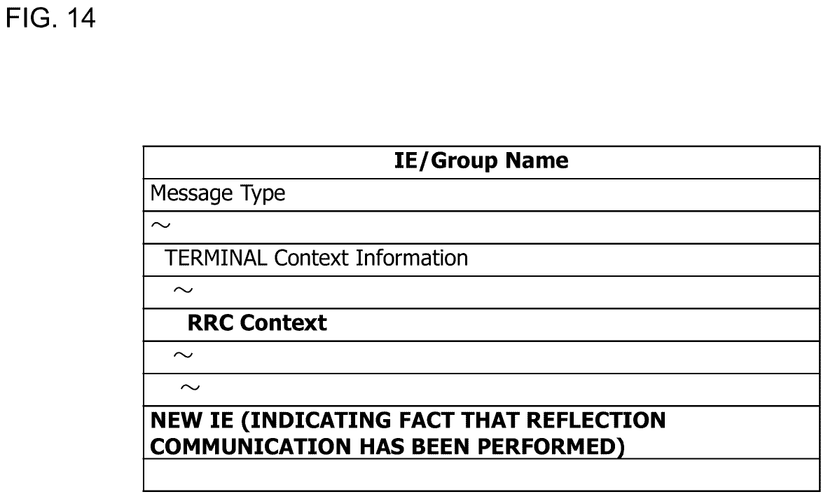

Further, the ping-pong avoidance indication may be transmitted in handover processing. FIG. 14 is a diagram illustrating an example of information elements (IE) and a group name in handover processing. The base station device 200-1 sets, for example, an RRC message informed to the terminal device 100 by the base station device 200-2 that is a handover destination in RRC Context. In the RRC message, a ping-pong avoidance HO condition is set.

The ping-pong avoidance HO condition is a condition on which handover to the base station device 200-1 that is a handover source by the terminal device 100 is tightened. The ping-pong avoidance HO condition is, for example, a condition on which the terminal device 100 is restrained from performing handover to the base station device 200-1 that is a handover source, and a value (offset value) at which the terminal device 100 does not perform handover to the base station device 200-1 unless a reception level higher than a reception level in normal handover is obtained is set. Further, the ping-pong avoidance HO condition may be, for example, a condition on which the terminal device 100 is prohibited to perform handover to the base station device 200-1 that is a handover source. Note that the prohibition or restraint of handover to the base station device 200-1 may be cancelled after a prescribed time elapses or when a prescribed condition is satisfied.

Further, a new information element (IE) may be defined to provide a notification of the fact that the terminal device 100 has performed reflection communication or a ping-pong avoidance HO condition.

### Example of Presence or Absence of Handover

By performing handover control according to the first embodiment, the terminal device 100 that is under reflection communication is liable to perform handover and is less liable to perform handover (ping-pong) to a source base station device 200.

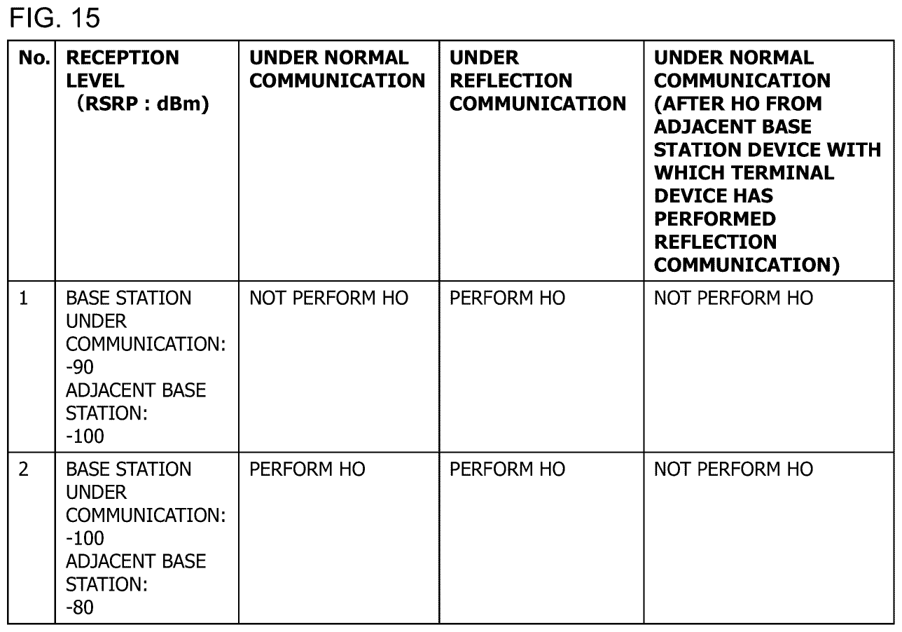

FIG. 15 is a diagram illustrating an example of the presence or absence of handover for each reception level. In FIG. 15, the reception levels are represented by reference signal received power (RSRP) and expressed in the unit dBm.

For example, a case where a reception level of a signal from a base station device that is under communication is −90 dBm and a reception level of a signal from an adjacent base station device is −100 dBm will be described.

Under normal communication, the terminal device 100 does not perform handover at the reception levels.

Further, the terminal device 100 does not perform handover in the same manner as under normal communication after handover from the adjacent base station device with which the terminal device 100 has performed reflection communication.

However, the terminal device 100 performs handover to the adjacent base station device since a condition for handover is low under reflection communication.

As described above, the terminal device 100 that is under reflection communication performs handover to an adjacent base station device even at reception levels at which the terminal device 100 does not perform handover under normal communication.

Further, for example, a case where a reception level of a signal from a base station device under communication is −100 dBm and a reception level of a signal from an adjacent base station device is −80 dBm will be described.

Under normal communication, the terminal device 100 performs handover to the adjacent base station device.

Further, under reflection communication, the terminal device 100 performs handover to the adjacent base station device in the same manner as under normal communication.

However, the terminal device 100 does not perform handover to the adjacent base station device after handover from the adjacent base station device with which the terminal device 100 has performed reflection communication since a condition for handover is high due to ping-pong avoidance processing or handover to the adjacent base station device is prohibited.

As described above, the terminal device 100 having performed handover from an adjacent base station device with which the terminal device 100 has performed reflection communication does not perform handover to the adjacent base station device even at reception levels at which the terminal device 100 performs handover under normal communication.

### Other Embodiments

The method for detecting reflection communication, the notification method for notifying a terminal device of a reflection communication HO condition, and the method of a ping-pong avoidance indication illustrated in the first embodiment may be combined with each other.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A base station device that performs normal communication to directly wirelessly connect to a terminal device or reflection communication to communicate with a terminal device using radio waves reflected by a reflection device, the base station device comprising:
a notifier configured to notify, when detecting a fact that the terminal device is under the reflection communication, the terminal device of a reflection communication handover condition for a case where the reflection communication is performed; and
a controller configured to perform, when the terminal device under the reflection communication with a movement source base station device performs handover, control to restrain the terminal device from performing handover to the movement source base station device.

2. The base station device according to claim 1, wherein
the reflection communication handover condition is a condition on which handover is more liable to be performed than a handover condition in the normal communication.

3. The base station device according to claim 2, wherein
a handover condition includes a reception level of a signal transmitted from a base station device, and
a reception level of the reflection communication handover condition is lower than a reception level of the handover condition in the normal communication.

4. The base station device according to claim 1, wherein
the controller acquires a fact that the terminal device has performed the reflection communication with the movement source base station device from the movement source base station device.

5. The base station device according to claim 1, wherein
the controller prohibits the terminal device from performing handover to the movement source base station device.

6. The base station device according to claim 1, wherein
the controller makes handover less liable to be performed on a movement source handover condition of the terminal device for the movement source base station device than a handover condition of the terminal device for a base station device other than the movement source base station device.

7. The base station device according to claim 6, wherein
a handover condition includes a reception level of a signal transmitted from a base station device, and
a reception level of a movement source handover condition of the terminal device for the movement source base station device is higher than a reception level of a handover condition of the terminal device for a base station device other than the movement source base station device.

8. The base station device according to claim 6, wherein
the controller acquires the movement source handover condition from the movement source base station device.

9. The base station device according to claim 6, wherein
the controller transmits the movement source handover condition to the terminal device.

10. A communication method of a base station device that performs normal communication to directly wirelessly connect to a terminal device or reflection communication to communicate with a terminal device using radio waves reflected by a reflection device, the communication method comprising:
notifying, when detecting a fact that the terminal device is under the reflection communication, the terminal device of a reflection communication handover condition for a case where the reflection communication is performed; and
performing, when the terminal device under the reflection communication with a movement source base station device performs handover, control to restrain the terminal device from performing handover to the movement source base station device.

11. A communication system including a terminal device, a reflection device, and a base station device, wherein
the reflection device transmits reflected waves generated by reflecting radio waves transmitted by the base station device or the terminal device,
the terminal device performs reflection communication using the reflected waves or normal communication to directly wirelessly connect to the base station device, and
the base station device:
notifies, when detecting a fact that a terminal device under communication with an own device is under the reflection communication, the terminal device of a reflection communication handover condition for a case where the reflection communication is performed, and
restrains, when the terminal device under the communication with the own device performs handover from the movement source base station device, the terminal device from performing handover to the movement source base station device.
